(19) United States
(12) Patent Application Publication
(10) Pub. No.: US 2010/0305949 A1
(43) Pub. Date: Dec. 2, 2010

(54) SPEECH SYNTHESIS DEVICE, SPEECH SYNTHESIS METHOD, AND SPEECH SYNTHESIS PROGRAM

(76) Inventors: Masanori Kato, Tokyo (JP); Yasuyuki Mitsui, Tokyo (JP); Reishi Kondo, Tokyo (JP)

Correspondence Address: Mr. Jackson Chen, 6535 N. STATE HWY 161, IRVING, TX, 75039, US

(21) Appl. No.: 12/744,807

(22) PCT Filed: Nov. 25, 2008
(86) PCT No.: PCT/JP2008/071351

§ 371 Date: May 26, 2010

(30) Foreign Application Priority Data
Nov. 28, 2007 (JP) 2007-307507

(51) Int. Cl. G10L 13/06

(52) U.S. Cl. 704/266; 704/E13.002

(57) ABSTRACT

It is possible to provide a speech synthesis device, speech synthesis method, and speech synthesis program which can improve a speech quality and reduce a calculation amount with a preferable balance between them. The speech synthesis device includes: a sub-score calculation unit (60/65) which calculates a segment selection sub-score for selecting an optimal segment; and a candidate narrowing unit (70/73) for narrowing the candidates according to the number of the candidate segments and the segment selection sub score. The speech synthesis device performs candidate narrowing by the sub score calculation unit (60/65) and the candidate narrowing unit (70/73) in the candidate selection process when generating a synthesized speech from an input text.

### REFERENCE TO RELATED APPLICATION

The present invention is based upon and claims the benefit of the priority of Japanese patent application No. 2007-307507 filed on Nov. 28, 2007, the disclosure of which is incorporated herein in its entirety by reference thereto.

### TECHNICAL FIELD

The present invention relates to a speech synthesis device, speech synthesis method, and speech synthesis program, and particularly to a speech synthesis device, speech synthesis method, and speech synthesis program that synthesize speech from a text.

### BACKGROUND ART

A variety of speech synthesis devices that analyze a text and generate synthesized speech from speech information indicated by the text using rule synthesis have been developed. FIG. 25 is a block diagram showing the configuration of a general rule-synthesis type speech synthesis device. The configurations and operations of speech synthesis devices having such a configuration are described in detail in, for instance, Non-Patent Documents 1 to 3 and Patent Documents 1 and 2.

The speech synthesis device shown in FIG. 25 comprises a language processing unit X1, a prosody generating unit X2, a segment selection unit X3 having a unit score calculation unit X11, a concatenation score calculation unit X13, and an optimal segment search unit X14, a segment information storage unit X4, and a waveform generating unit X5. The segment information storage unit X4 stores speech segments generated for each speech synthesis unit and the attribute information of each speech segment. Here, the speech segment is information used for generating the waveform of a synthesized speech sound and is mostly extracted from the waveforms of recorded natural speech sounds. Examples of the speech segments are a speech waveform itself cut out for each synthesis unit, linear prediction analysis parameters, and cepstrum coefficients. Further, the attribute information of the speech segment includes the phonemic environment of the natural speech sound from which each speech segment is extracted, and sound and prosodic information such as pitch frequency, amplitude, and duration information. As the speech synthesis unit, phoneme, CV, CVC, or VCV (V denotes a vowel; C a consonant) is used mostly. Non-Patent Documents 1 and 3 describe the length of the speech segment and the synthesis unit in detail.

The language processing unit X1 analyzes an input text by reading it and performing morpheme and syntactic analyses on it, and outputs symbol strings indicating how the text is “read” such as phonetic segment symbols, and the lexical category, conjugation, accent type of each morpheme as language processing results to the prosody generating unit X2 and the segment selection unit X3.

The prosody generating unit X2 generates the prosody information (information relating to pitch, duration, and power) of synthesized speech according to the language processing results outputted from the language processing unit X1, and outputs it to the segment selection unit X3 and the waveform generating unit X5. The segment selection unit X3 selects speech segments having high suitability in terms of the language processing results and the generated prosody information from the speech segments stored in the segment information storage unit X4, and outputs the selected speech segments with their attribute information to the waveform generating unit X5. The waveform generating unit X5 generates waveforms having prosodies close to the prosodies generated by the prosody generating unit X2 from the selected speech segments, connects these waveforms, and output the result as synthesized speech.

The segment selection unit X3 derives information (called “target segment environment” hereinafter) indicating the characteristics of the target synthesized speech from the inputted language processing results and the prosody information for each predetermined synthesis unit. The target segment environment includes information such as the names of the corresponding, preceding, and succeeding phonemes, whether or not there is the stress, the distance from the accent nucleus, the pitch frequency and power of the synthesis unit, the duration of the unit, the cepstrum, MFCCs (Mel Frequency Cepstral Coefficients), and the Δ amount (the variation per unit time) of these factors. Next, having derived the target segment environment, the segment selection unit X3 selects a plurality of speech segments matching particular information (mainly the corresponding phoneme), specified by the target segment environment, from the segment information storage unit X4. The selected speech segments become candidates for the speech segments used for synthesis. Then, the “score (or cost)” of each selected candidate segment that indicates the suitability of a candidate as a speech segment used for synthesis is calculated. Since the aim is to generate high quality synthesized speech, the higher the score (or the lower the cost), the higher the speech quality of the synthesized sound. In other words, the score is an indicator for estimating the degree of degradation of the quality of the synthesized speech.

Here, the segment selection unit X3 calculates two kinds of scores: unit score and concatenation score. The unit score indicates the estimated degree of speech quality degradation caused by using the candidate segment in the target segment environment, and is calculated according to the degree of similarity between the segment environment of the candidate segment and the target segment environment. Meanwhile, the concatenation score indicates the estimated degree of speech quality degradation caused when the segment environments of connected speech segments are discontinuous, and is calculated according to the degree of affinity between the segment environments of adjacent candidate segments. A variety of methods are proposed for calculating the unit score and the concatenation score. Generally, the unit score is calculated using the information included in the target segment environment, and the concatenation score is calculated using the pitch frequency, the cepstrum, MFCCs, the short-time autocorrelation, and the power on the connection border of segments, and the Δ amount of these factors. As described, the unit score and the concatenation score are calculated using multiple pieces of various information relating to segments, such as the pitch frequency, the cepstrum, and the power.

Regarding the configuration shown in FIG. 25, after having calculated the unit score and the concatenation score for each segment using the unit score calculation unit X11 and the concatenation score calculation unit X13, the segment selection unit X3 uniquely derives a speech segment having the largest concatenation and unit scores for each synthesis unit. The segment derived according to the largest scores is called the “optimal segment” since it was selected from the candidate segments as the segment most suitable for speech synthesis. After having derived the optimal segment for each synthesis unit using the optimal segment search unit X14, the segment selection unit X3 finally outputs a series of the optimal segments (optimal segment series) to the waveform generating unit X5 as a segment selection result.

The segment selection unit X3 needs to calculate the unit score and the concatenation score for all the candidates for the optimal segment in order to derive the optimal segment series. As the number of the segments stored in the segment information storage unit, i.e., the number of the candidate segments, increases, so does the calculation amount required for calculating the scores for each of the segments, and as a result, a greatly longer processing time will be required from the text input to the generation of synthesized speech. Therefore, basic means for reducing the calculation amount is to reduce the number of the candidate segments, for which the unit score and the concatenation score need to be calculated, however, significant speech quality degradation may occur if a wrong method is employed to reduce the number of the segments. As a result, methods for reducing the calculation amount required for the segment selection processing without causing significant speech quality degradation have been investigated.

For instance, Patent Document 3 proposes a method that reduces the number of the segments without negatively influencing the speech quality by investigating how frequently the segments stored in the segment information storage unit are used during the speech synthesis and excluding infrequently used segments from the segment information storage unit. Further, Patent Document 4 proposes a method that reduces the calculation amount required for the segment selection by excluding segments having low unit sub-cost from being a candidate, thereby reducing the number of segments for which the unit sub-cost and the concatenation cost are calculated.

[Patent Document 1]
Japanese Patent Kokai Publication No. JP-P2005-91551A

[Patent Document 2]
Japanese Patent Kokai Publication No. JP-P2006-84854A

[Patent Document 3]
Japanese Patent Kokai Publication No. JP-P2004-037605A

[Patent Document 4]
Japanese Patent Kokai Publication No. JP-P2005-265895A

[Non-Patent Document 1]
X. Huang, A. Acero, H. Hon, “Spoken Language Processing,” Prentice Hall, pp. 689-836, 2001.

[Non-Patent Document 2]
Y. Ishikawa, “Prosodic Control for Japanese Text-to-Speech Synthesis,” The Institute of Electronics, Information and Communication Engineers Technical Report, Vol. 100, No. 392, pp. 27-34, 2000.

[Non-Patent Document 3]
M. Abe, “An Introduction to Speech Synthesis Units,” The Institute of Electronics, Information and Communication Engineers Technical Report, Vol. 100, No. 392, pp. 35-42, 2000.

### DISCLOSURE OF THE INVENTION

### Problems to be Solved by the Invention

The entire disclosures of the aforementioned Patent Documents 1 to 4 and Non-Patent Documents 1 to 3 are incorporated herein by reference thereto.

The following analysis is given from the viewpoint of the present invention.

In the present application, a score derived for each piece of information is defined as “sub-score” (also called “sub cost”) hereinafter. For instance, sub-scores are a score calculated from the similarity between the pitch frequency of the target segment environment and the pitch frequency of a candidate segment as far as the unit score is concerned, and a score calculated from the similarity between the cepstrums of adjacent candidate segments as far as the concatenation score is concerned. Sub-scores related to the unit score are called “unit sub-scores” and sub-scores related to the concatenation score are called “concatenation sub-scores.” Further, regarding the concatenation score, when two segments are continuous in the original speech waveform, the value of the concatenation score is maximum since the segment environment between these segments is perfectly continuous.

However, the methods for reducing the segments in the conventional speech synthesis devices described in the aforementioned Patent Documents and Non-Patent Documents have the following problems.

First, since the method described in Patent Document 3 excludes segments according to the frequency of use, segments may be excluded from being candidates without calculating the sub-scores. Even if a segment is not used frequently, it may have a high score depending on the content of the input text. As a result, speech quality will deteriorate for an input text for which segments excluded based on the frequency of use have high scores.

Further, Patent Document 4 discloses the configuration in which candidates are narrowed down in two or more stages in order to reduce the calculation amount, however, concrete means or criteria for appropriately narrowing down the candidates are not disclosed.

Therefore, the speech synthesis devices described in Patent Documents 3 and 4 are able to reduce the calculation amount, but cannot sufficiently prevent speech quality degradation.

The present invention aims at solving the problems described above, and it is an object to provide a speech synthesis device, speech synthesis method, and speech synthesis program capable of realizing speech quality improvement and the reduction of the calculation amount in a balanced manner.

### Means to Solve the Problems

According to a first aspect of the present invention, there is a provided a speech synthesis device comprising: a sub-score calculation unit that calculates a segment selection sub-score for selecting an optimal segment, and a candidate narrowing unit that narrows down candidates according to the number of candidate segments and the segment selection sub-score.

According to a second aspect of the present invention, there is provided a speech synthesis method, in a speech synthesis device that generates synthesized speech from an input text, comprising a step of calculating a segment selection sub-score for selecting an optimal segment and of narrowing down candidates according to the number of candidate segments and the segment selection sub-score in a process of selecting an optimal segment.

According to a third aspect of the present invention, there is a provided a program having a computer, constituting a speech synthesis device that generates synthesized speech from an input text, execute: processing of calculating a segment selection sub-score for selecting an optimal segment, and candidate narrowing processing of narrowing down candidates according to the number of candidate segments and a segment selection sub-score used when an optimal segment is selected; in a process of selecting an optimal segment for generating synthesized speech from an input text.

### MERITORIOUS EFFECTS OF THE INVENTION

According to the present invention, it becomes possible to output synthesized speech without having the speech quality degradation caused by the reduction of the calculation amount. The reason is that segments having the prospect of contributing to high speech quality are selected, taking advantage of the tendency that the sub-scores of optimal segments rise as the number of the candidates increases.

### BRIEF DESCRIPTION OF THE DRAWINGS

FIG. 1 is a drawing for explaining the basic principle of a speech synthesis device of the present invention.

FIG. 2 is a block diagram showing the configuration of a speech synthesis device of a first exemplary embodiment relating to the present invention.

FIG. 3 is a block diagram showing a detailed configuration of a threshold value calculation unit shown in FIG. 2.

FIG. 4 is a flowchart for explaining the operation of the speech synthesis device of the first exemplary embodiment of the present invention.

FIG. 5 is a flowchart for explaining the operation of the threshold value calculation unit shown in FIG. 2.

FIG. 6 is an example of the frequency distributions of optimal unit sub-scores obtained by an optimal segment sub-score analyzing unit shown in FIG. 3.

FIG. 7 is an example of a threshold value function generated by a threshold value function generating unit shown in FIG. 3.

FIG. 8 is an example of the threshold value function generated by the threshold value function generating unit shown in FIG. 3.

FIG. 9 is an example of the threshold value function generated by the threshold value function generating unit shown in FIG. 3.

FIG. 10 is a block diagram showing the configuration of a speech synthesis device of a second exemplary embodiment of the present invention.

FIG. 11 is a block diagram showing a detailed configuration of a weighting function selection unit shown in FIG. 10.

FIG. 12 is a flowchart for explaining the operation of the speech synthesis device of the second exemplary embodiment of the present invention.

FIG. 13 is a flowchart for explaining the operation of a weighting function generating unit shown in FIG. 11.

FIG. 14 is an example of a weighting function generated by the weighting function generating unit in FIG. 11.

FIG. 15 is an example of the weighting function generated by the weighting function generating unit in FIG. 11.

FIG. 16 is an example of the weighting function generated by the weighting function generating unit in FIG. 11.

FIG. 17 is a block diagram showing the configuration of a speech synthesis device of a third exemplary embodiment of the present invention.

FIG. 18 is a block diagram showing a detailed configuration of a threshold value calculation unit shown in FIG. 17.

FIG. 19 is a flowchart for explaining the operation of the speech synthesis device of the third exemplary embodiment of the present invention.

FIG. 20 is a flowchart for explaining the operation of the threshold value calculation unit shown in FIG. 18.

FIG. 21 is a block diagram showing the configuration of a speech synthesis device of a fourth exemplary embodiment of the present invention.

FIG. 22 is a block diagram showing a detailed configuration of a threshold value calculation unit shown in FIG. 21.

FIG. 23 is a flowchart for explaining the operation of the speech synthesis device of the fourth exemplary embodiment of the present invention.

FIG. 24 is a flowchart for explaining the operation of the threshold value calculation unit shown in FIG. 22.

FIG. 25 is a configuration diagram showing an example of a general rule-synthesis type speech synthesis device.

### EXPLANATIONS OF SYMBOLS

1: language processing unit
2: prosody generating unit
3: segment selection unit
4: segment information storage unit
5: waveform generating unit
11, 110, 111, 112: unit score calculation unit
13, 131: concatenation score calculation unit
14: optimal segment search unit
60/65: sub-score calculation unit
60₁, 60₂, . . . , 60_{N}: first to Nth unit sub-score calculation unit
65₁, 65₂, . . . , 65_{N}: first to Nth concatenation sub-score calculation unit
70/73: candidate narrowing unit
70₁, 70₂, . . . , 70_{N}: first to Nth candidate narrowing unit
71₁, 71₂, . . . , 71_{N}: first to Nth candidate narrowing unit
73₁, 73₂, . . . , 73_{N}: first to Nth candidate narrowing unit
80₁, 80₂, . . . , 80_{N}: first to Nth threshold value calculation unit
81₁, 81₂, . . . , 81_{N}: first to Nth weighting function selection unit
82₂, 82₃, . . . , 82_{N}: second to Nth threshold value calculation unit
83₁, 83₂, . . . , 83_{N}: first to Nth threshold value calculation unit
121/122: sub-score compiling unit
121: unit sub-score compiling unit
122: concatenation sub-score compiling unit
200, 201: number-of-candidates obtaining unit
800₁\: text storage unit
801_{M}: language processing unit
802_{M}: prosody generating unit
803_{M}: segment selection unit
804_{M}: segment information storage unit
805_{M}: Mth unit sub-score calculation unit
807_{M}: optimal segment sub-score analyzing unit
808_{M}: threshold value function generating unit
809_{M}: threshold value calculation unit
811_{M}: 811₂, . . . , 811_{N},: first to Nth weighting unit
818_{M}: weighting function generating unit
851_{M}: weighting function storage unit
852_{M}: function selection unit
853_{M}: threshold value correction unit
855_{M}: Mth concatenation sub-score calculation unit

### PREFERRED MODES FOR CARRYING OUT THE INVENTION

Next, preferred modes for carrying out the present invention will be described in detail with reference to the drawings.

### SUMMARY OF THE INVENTION

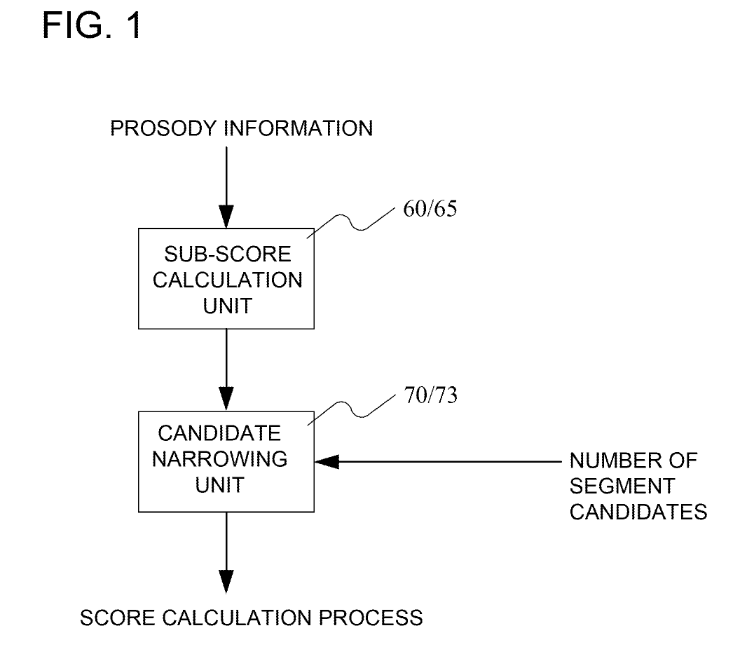

FIG. 1 is a drawing for explaining the basic principle of a speech synthesis device of the present invention. The speech synthesis device relating to the present invention comprises a sub-score calculation unit 60/65 that calculates a segment selection sub score for selecting an optimal segment, and a candidate narrowing unit 70/73 that narrows the candidates according to the number of the candidate segments and the segment selection sub-score. The speech synthesis device narrows down the candidates using the sub-score calculation unit 60/65 and the candidate narrowing unit 70/73 during an optimal segment selection process when generating synthesized speech from an input text.

The segment selection sub-scores of the candidates narrowed down by the candidate narrowing unit 70/73 are compiled by a sub-score compiling unit provided separately, and the optimal segment is selected.

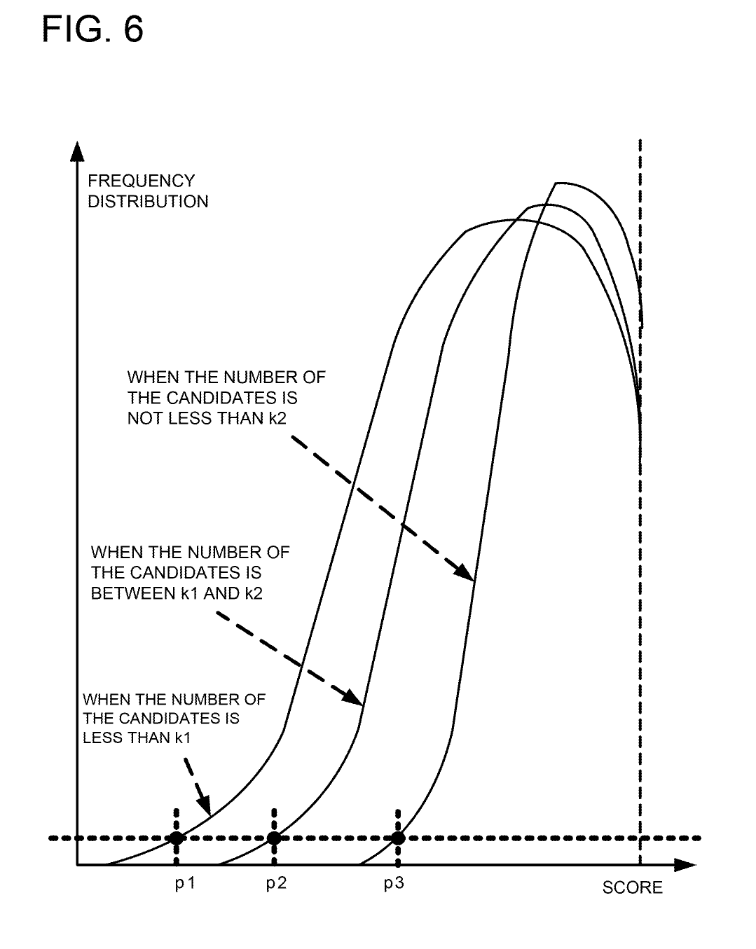

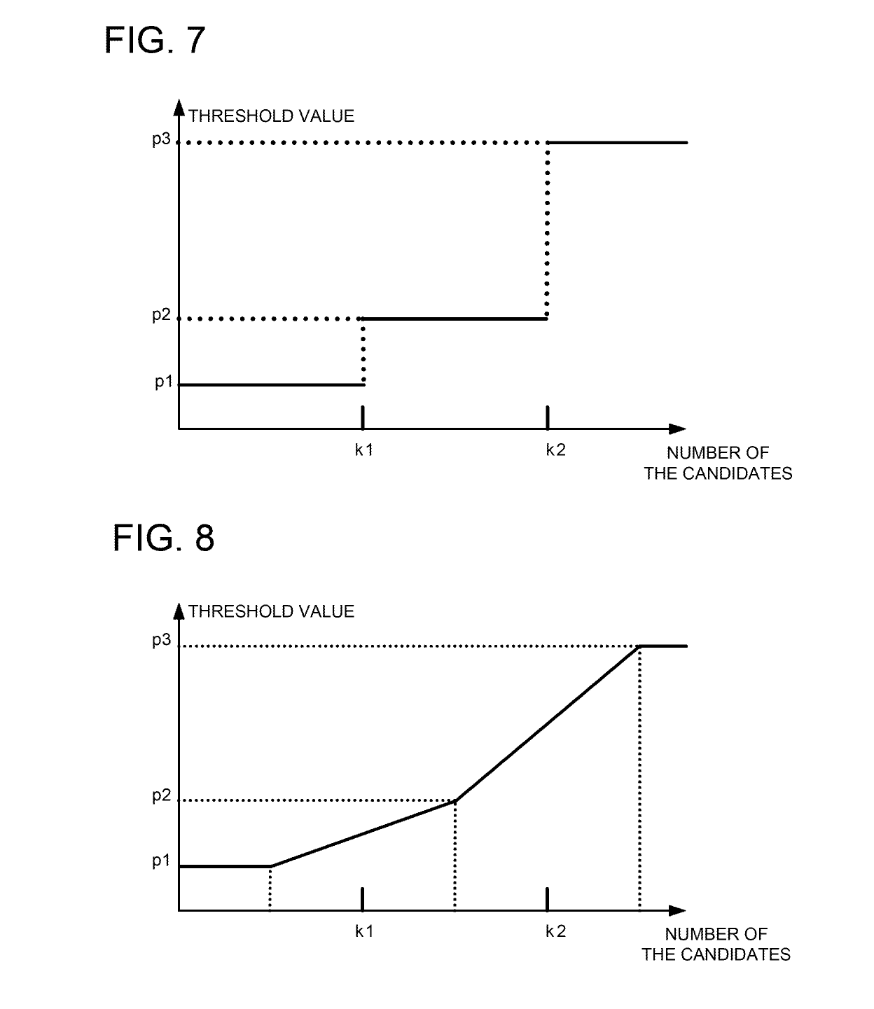

The speech synthesis device relating to the present invention narrows down the candidates according to the segment selection sub-score, applying different threshold values (FIGS. 7 to 9) according to, for instance, the number of the candidate segments, and selects the optimal segment from the eventually remaining candidates. Generally, since the sub-score of the optimal segment tends to get higher as the number of the candidate segments increases (refer to FIG. 6), narrowing down the candidates using the threshold values described above is effective in terms of both the reduction of the calculation amount and the improvement of speech quality.

For the segment selection sub-score, either a unit sub-score or concatenation sub-score can be used.

A threshold value calculation unit that derives the threshold values according to the number of the candidate segments may be provided in the candidate narrowing unit 70/73. In this case, the candidate narrowing unit 70/73 can narrow down the candidates according to these threshold values and the segment selection sub-score.

Based on the fact that having more candidates increases the probability of having a segment close to the target value, the threshold value calculation unit may operate so as to derive a higher threshold value when the number of the candidate segments is high than a case where it is low.

For the calculation of the threshold values by the threshold value calculation unit, the segment selection sub-score can be used. Particularly, more efficient threshold values can be obtained by deriving threshold values according to statistics of the segment selection sub-scores of the optimal segments.

For instance, a weighting function selection unit that selects a weighting function according to the number of the candidate segments and a weighting unit that weights the segment selection score according to the weighting function and the segment selection score may be provided precedent to the candidate narrowing unit. In this case, the candidate narrowing unit 70/73 narrows down the candidates according to the weighted segment selection score.

### First Exemplary Embodiment

Next, a first exemplary embodiment of the present invention will be described in detail with reference to the drawings.

### [1-1] The Configuration of a Speech Synthesis Device According to the First Exemplary Embodiment

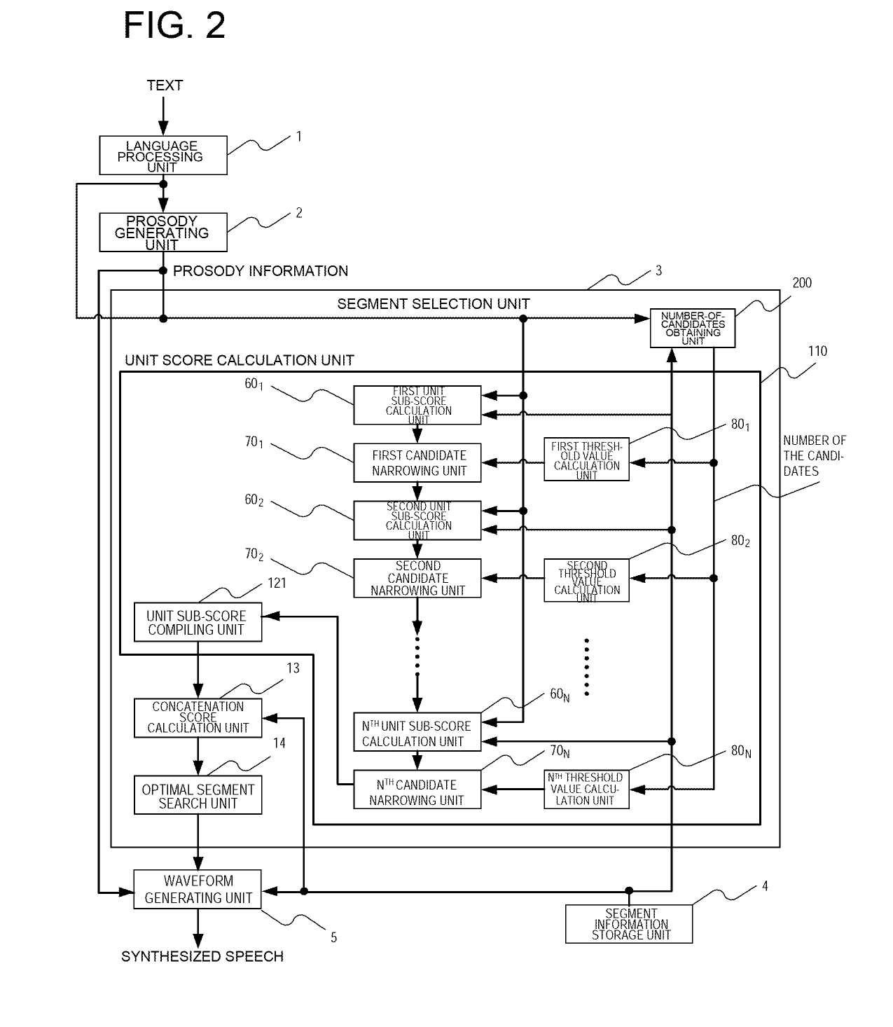

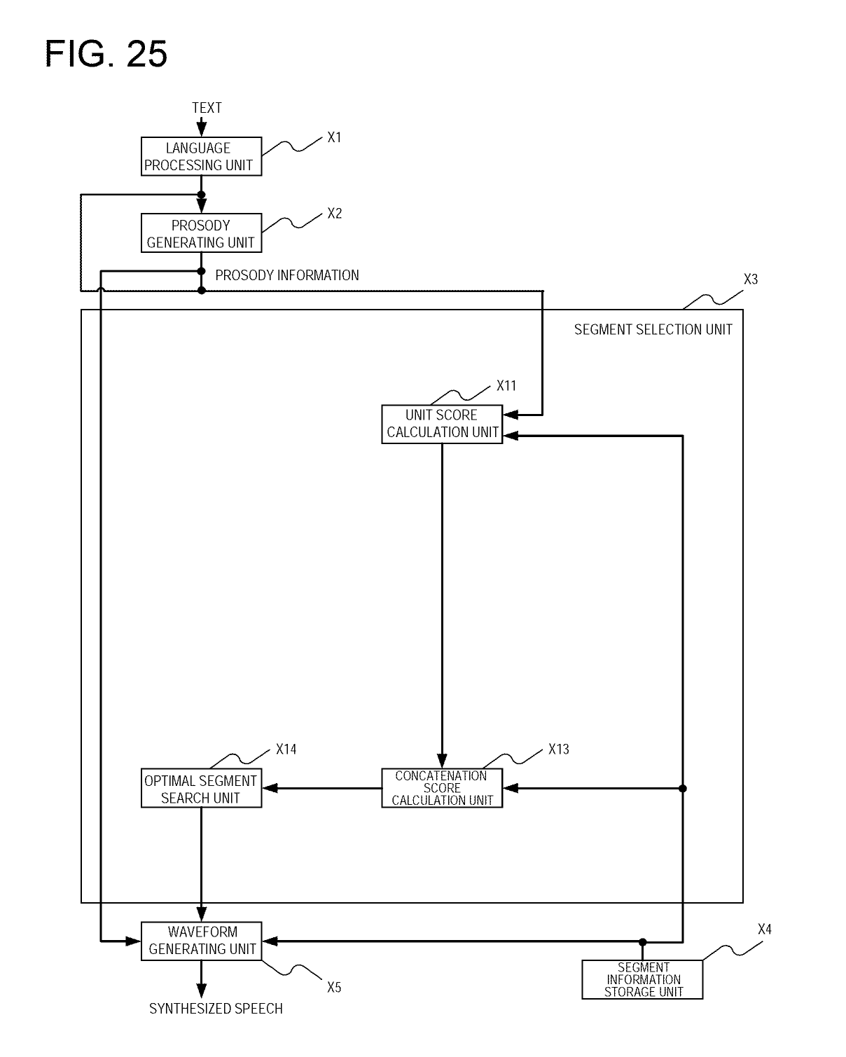

FIG. 2 is a block diagram showing the configuration of the first exemplary embodiment of the present invention. A language processing unit 1, a prosody generating unit 2, a concatenation score calculation unit 13 and an optimal segments search unit 14 in a segment selection unit 3, a segment information storage unit 4, and a waveform generating unit 5 in FIG. 2 respectively correspond to the language processing unit X1, the prosody generating unit X2, the concatenation score calculation unit X13, the optimal segments search unit X14, the segment information storage unit X4, and the waveform generating unit X5 in FIG. 25. Therefore, the speech synthesis device of the present exemplary embodiment differs from the general rule-synthesis type speech synthesis device in FIG. 25 in that a number-of-candidates obtaining unit 200, first to Nth unit sub-score calculation units 60₁ to 60ₙ, first to Nth candidate narrowing units 70₁ to 70ₙ, first to Nth threshold value calculation units 80₁ to 80ₙ, and a unit sub-score compiling unit 121 are added.

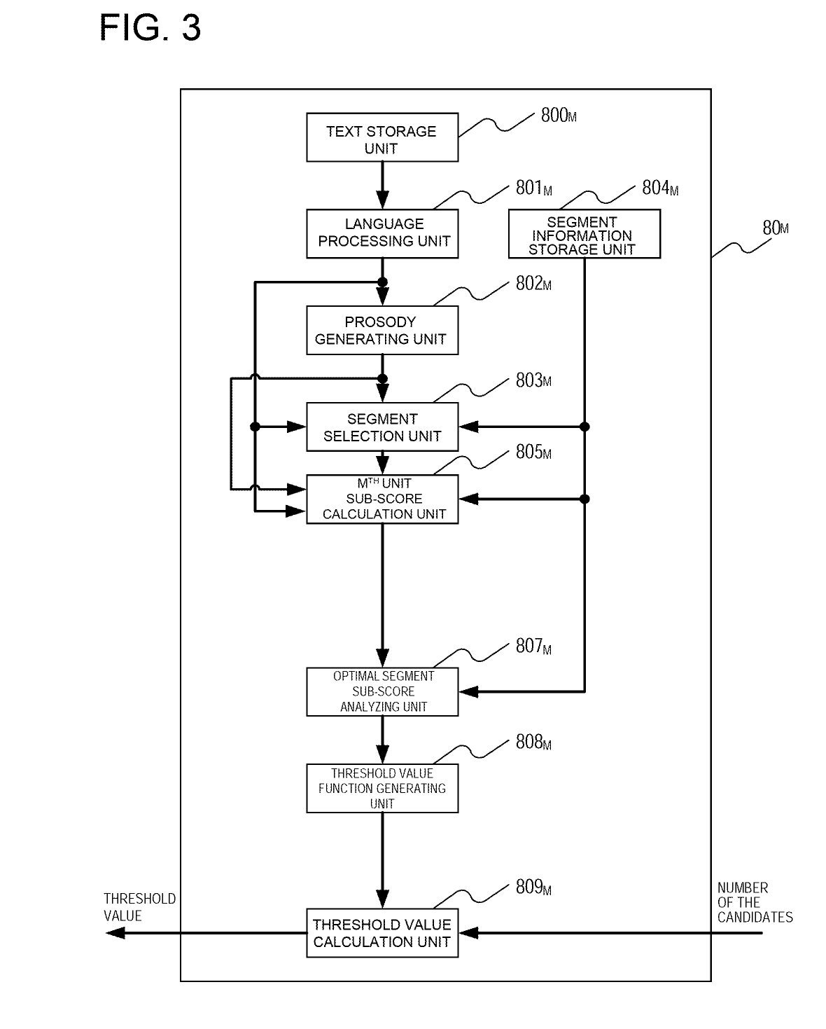

FIG. 3 is a block diagram showing the configuration of the threshold value calculation unit 80_{M} shown in FIG. 2 (where M is any integer from 1 to N). In FIG. 3, the threshold value calculation unit 80_{M} comprises a text storage unit 800_{M} a language processing unit 801_{M}, a prosody generating unit 802_{M}, a segment selection unit 803_{M}, a segment information storage unit 804_{M}, an Mth unit sub-score calculation unit 805_{M}, an optimal segment sub-score analyzing unit 807_{M}, a threshold value function generating unit 808_{M}, and a threshold value calculation unit 809_{M}.

The text storage unit 800_{M} stores a large amount of texts required for analyzing and extracting the characteristics of the unit sub-scores of the optimal segments.

In order to derive an appropriate threshold value, it is preferable that the operations of the language processing unit 801_{M}, the prosody generating unit 802_{M}, the segment selection unit 803_{M}, and the segment information storage unit 804_{M} be identical to the operations of the language processing unit 1, the prosody generating unit 2, the segment selection unit 3, and the segment information storage unit 4 in FIG. 2, respectively. Therefore, explanations will be made with the assumption that the language processing unit 801_{M}, the prosody generating unit 802_{M}, the segment selection unit 803_{M}, and the segment information storage unit 804_{M} are equivalent to the language processing unit 1, the prosody generating unit 2, the segment selection unit 3, and the segment information storage unit 4 in FIG. 2 respectively in the present exemplary embodiment.

The operation of the speech synthesis device of the first exemplary embodiment will be described in detail with reference to the block diagrams in FIGS. 2 and 3, focusing on the differences mentioned above.

### [1-2] The Operation of the Speech Synthesis Device of the First Exemplary Embodiment

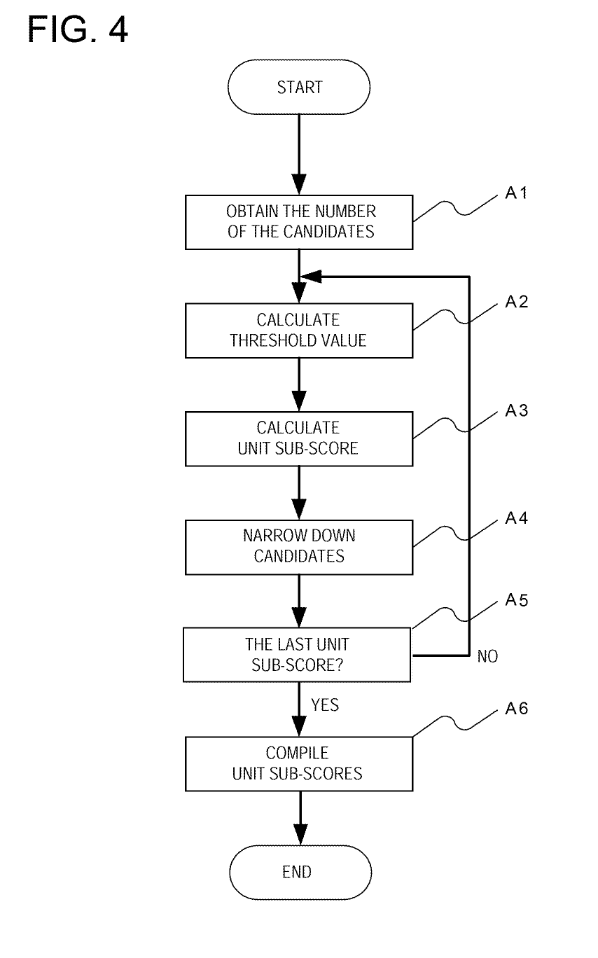

FIG. 4 is a flowchart for explaining the operation of the first exemplary embodiment of the present invention. With reference to the flowchart in FIG. 4, according to the language processing results supplied by the language processing unit 1 and the number of the candidates for each segment supplied by the segment information storage unit 4, the number-of-candidates obtaining unit 200 obtains the number of corresponding candidate segments, and transmits the information to the first to the Nth threshold value calculation units 80₁ to 80_{N} (step A1).

The first threshold value calculation unit 80₁ calculates a threshold value, which will be a reference value for narrowing down the candidates, from the number of the candidates supplied by the number-of-candidates obtaining unit 200, and transmits the information to the first candidate narrowing unit 70₁ (step A2).

The first unit sub-score calculation unit 60₁ calculates a first unit sub-score according to the language processing results supplied by the language processing unit 1, the prosody information supplied by the prosody generating unit 2, and segment information stored in the segment information storage unit, and transmits the sub-score to the first candidate narrowing unit 70₁ (step A3).

The first candidate narrowing unit 70₁ compares the first unit sub-score of each candidate segment supplied by the first unit sub-score calculation unit 60₁ to the threshold value supplied by the first threshold value calculation unit 80₁, excludes candidate segments having unit sub-scores lower than the threshold value, and transmits the remaining candidate segments and their unit sub-scores to the second unit sub-score calculation unit 60₂ (step A4).

The processing from the step A2 to the step A4 is similarly repeated by the second threshold value calculation unit, the second unit sub-score calculation unit, and the second candidate narrowing unit through the Nth threshold value calculation unit, the Nth unit sub-score calculation unit, and the Nth candidate narrowing unit until the last unit sub-score is calculated (step A5). The last Nth candidate narrowing unit 70_{N} transmits the remaining candidate segments and their first through Nth unit sub-scores to the unit sub-score compiling unit 121.

The unit sub-score compiling unit 121 derives a unit score corresponding to each candidate segment according to the candidate segments supplied by the Nth candidate narrowing unit 70_{N} and their first through Nth unit sub-scores, and transmits the unit scores along with the candidate segments to the concatenation score calculation unit 13 (step A6).

The unit score can be derived from the unit sub-scores by, for instance, deeming a weighted sum of the unit sub-scores the unit score. In other words, when the unit sub-score is Ci and a weighting coefficient is wi, the unit score C can be derived by the following expression

$$C = {\sum }_{i = 1}^{N} {w}_{i} Ci \qquad [ Expression 1 ]$$

Note that it is not necessary to calculate the threshold values and narrow down the candidates for all the kinds of sub-scores. The method described above in which the threshold value is derived according to the number of the candidates is expected to be highly effective for sub-scores such as pitch, duration, power, cepstrum, and MFCC. This is because, as the number of the candidates increases, so does the probability of having a candidate segment close to the target value of the target segment environment, and conversely, as the number of the candidates decreases, so does the probability of having a candidate segment close to the target value. On the other hand, it is difficult to expect high efficacy for sub-scores such as the names of the corresponding, preceding, and succeeding phonemes, whether or not there is the stress, and the distance from the accent nucleus since the scores are discrete and the value range is not large.

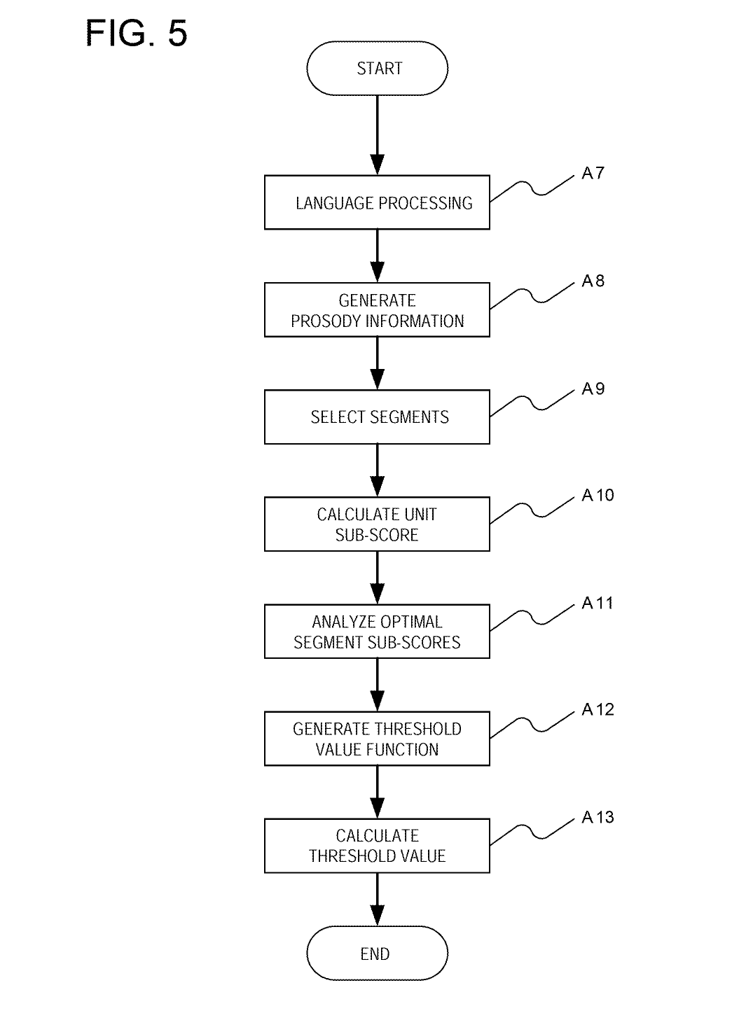

Here, how the threshold value is derived in the step A2 will be described. FIG. 5 is a flowchart for explaining the operation of the threshold value calculation unit shown in FIG. 3.

With reference to the flowchart in FIG. 5, the language processing unit 801_{M} performs language processing on a text supplied by the text storage unit 800_{M}, and transmits the language processing results to the prosody generating unit 802_{M} (step A7).

The prosody generating unit 802_{M} generates the prosody information for synthesized speech according to the language processing results supplied by the language processing unit 801_{M}, and transmits the information to the segment selection unit 803_{M} (step A8).

The segment selection unit 803_{M} derives the optimal segment according to the language processing results supplied by the language processing unit 801_{M}, the prosody information supplied by the prosody generating unit 802_{M}, and the segment information stored in the segment information storage unit 804_{M}, and transmits the optimal segment to the Mth unit sub-score calculation unit 805_{M} (step A9).

The Mth unit sub-score calculation unit 805_{M} calculates the Mth unit sub-score of the optimal segment supplied by the segment selection unit 803_{M} according to the language processing results supplied by the language processing unit 801_{M}, the prosody information supplied by the prosody generating unit 802_{M}, and the segment information stored in the segment information storage unit 804_{M}, and transmits the sub-score to the optimal segment sub-score analyzing unit 807_{M} (step A10).

The optimal segment sub-score analyzing unit 807_{M} differs from the Mth unit sub-score calculation unit 60_{M} in FIG. 2 in that the optimal segment sub-score analyzing unit 807_{M} calculates the Mth unit sub-score only for the optimal segments obtained by the segment selection unit 803_{M} while the Mth unit sub-score calculation unit 60_{M} calculates the Mth unit sub-score for all the candidate segments.

Regarding the details of the operations of the language processing unit 801_{M}, the prosody generating unit 802_{M}, the segment selection unit 803_{M}, the segment information storage unit 804_{M}, and the Mth unit sub-score calculation unit 805_{M}, since they are equivalent to the operations of the language processing unit 1, the prosody generating unit 2, the segment selection unit 3, the segment information storage unit 4, and the Mth unit sub-score calculation unit 60_{M} in FIG. 2 respectively, the explanations of them will be omitted.

The optimal segment sub-score analyzing unit 807_{M} analyzes the Mth unit sub-scores of the optimal segments supplied by the segment information storage unit 804_{M} and the Mth unit sub-score calculation unit 805_{M}, and transmits an analysis value, which will be the reference value when the threshold value function is designed, to the threshold value function generating unit 808_{M} (step A11).

The object of the optimal segment sub-score analyzing unit 807_{M} is to analyze the unit sub-score of the optimal segment, and derive reference value and analysis value useful for designing the threshold value function that calculates the threshold value for effectively narrowing the candidates.

When the candidates are narrowed down, by excluding as many non-optimal segments as possible from being the candidates, the candidates are effectively narrowed down, thereby greatly reducing the calculation amount with small speech quality degradation. Therefore it is important to obtain the characteristics of the sub-scores so that the differences between the optimal segments selected eventually and the standard segments are clear. This can be achieved by, for instance, deriving statistical values such as an average and distribution from the sub-scores of a large number of the optimal segments or studying the frequency distribution.

In the present example, a method in which the frequency distributions of the scores are derived for different numbers of the candidates in the optimal segment sub-score analyzing unit 807_{M} and the analysis value transmitted to the threshold value function generating unit 808_{M} is derived from the frequency distributions will be described.

FIG. 6 is an example of the frequency distributions derived for different numbers of the candidates. Assume that k1 and k2 are integers equal to or greater than 0, and k1 is smaller than k2. As shown in FIG. 6, more optimal segments having high scores tend to appear as the number of the candidates increases. This is because the unit sub-score scores the difference and distance from the target value, and the probability of having segments close to the target value improves when there is a large number of the candidates. Conversely, when there is a small number of the candidates, even optimal segments often cannot achieve high scores since the probability of having segments close to the target value decreases. From these frequency distributions, a score (rejection or discard region) where the occurrence probability of the optimal segments is sufficiently low can be derived.

In the example shown in FIG. 6, the aforementioned scores (rejection regions) are: (below) p1 when the number of the candidates is less than k1, (below) p2 when the number of the candidates is between k1 and k2, and (below) p3 when the number of the candidates is more than k2. As shown in FIG. 6, the relation between p1, p2, and p3 is generally p1<p2<p3. p1, p2, and p3, i.e., those scores where the occurrence probability of the optimal segments is sufficiently low for different numbers of the candidates, are transmitted to the threshold value function generating unit 808_{M} along with the numbers of the candidates k1 and k2 as the analysis results by the optimal segment sub-score analyzing unit 807_{M}.

According to the analysis value supplied by the optimal segment sub-score analyzing unit 807_{M}, the threshold value function generating unit 808_{M} derives the threshold value function that derives the threshold value from the number of the candidates, and transmits the threshold value function to the threshold value calculation unit 809_{M} (step A12). In the present example, explanations will be made with the assumption that the analysis values supplied by the optimal segment sub-score analyzing unit 807M are k1, k2, p1, p2, and p3 described above.

FIGS. 7 to 9 show examples of the threshold value function designed based on k1, k2, p1, p2, and p3. FIG. 7 shows a staircase like function, on which the analysis results by the optimal segment sub-score analyzing unit 807_{M} are directly reflected.

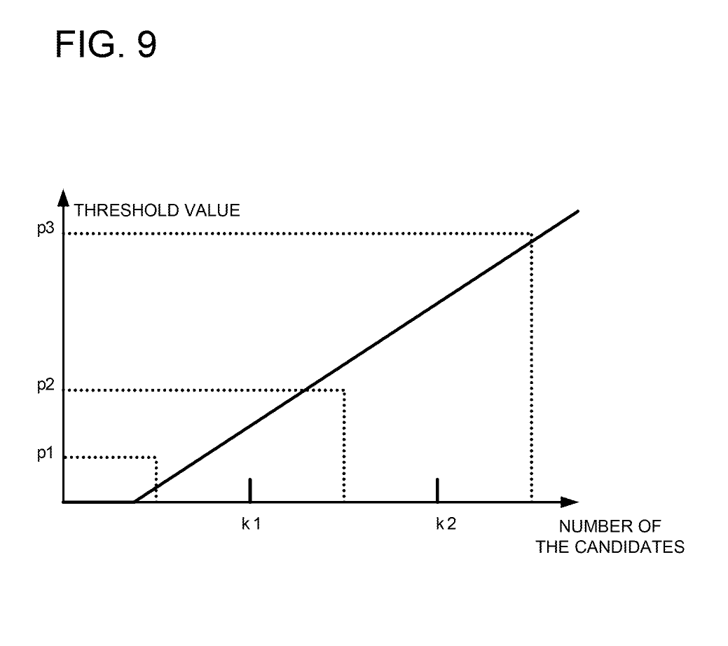

Meanwhile, considering that the number of the candidates and the threshold values are proportional to each other, a diode function that passes through p1, p2, and p3 while keeping a distance from k1 and k2, as shown in FIG. 8, can be expected to obtain threshold values more effective than those in FIG. 7. Further, it is possible to design a function that emphasizes the proportional relation between the number of the candidates and the threshold value as shown in FIG. 9. These functions can be used in combination with each other, depending on the kind of sub-score.

It is preferred that the design of the threshold value function, i.e., the processing from the step A7 to the step A12 in the flowchart in FIG. 5, be performed prior to the speech synthesis processing in order to reduce the calculation amount. Further, when the threshold value function is designed, the fact that the number of the candidates and the threshold values are proportional to each other is the condition demanded. Therefore, similar effects can be obtained with a simple linear or poly-line function (oresen) where the gradient is properly set without collecting statistics as in the present example.

The threshold value calculation unit 809_{M} derives the threshold value according to the threshold value function supplied by the threshold value function generating unit 808_{M} and the number of the candidates supplied by the number-of-candidates obtaining unit 200 in FIG. 2, and transmits the threshold value to the Mth candidate narrowing unit 70_{M} (step A13). The threshold value function is a function for the number of the candidates as shown in FIGS. 7 to 9. For instance, when the function shown in FIG. 7 is given as the threshold value function, the threshold value p1 is calculated from the number of the candidates less than k1.

### [1-3] The Effects of the Speech Synthesis Device According to the First Exemplary Embodiment

In the present exemplary embodiment, the speech synthesis device derives the threshold value for narrowing down the candidates from the number of the candidates, utilizing the fact that the sub-scores of the optimal segments rise as the number of the candidates increases. Further, the speech synthesis device excludes segments having low sub-scores from being the candidates using the threshold value derived according to the number of the candidates. As a result, with a high probability, it is possible to exclude segments having a low possibility of being selected as an optimal segment while keeping segments having a prospect of achieving high speech quality. Particularly, the threshold value function that derives the threshold value from the number of the candidates is determined based on the statistics of the sub-scores of the optimal segments. As a result, the possibility of excluding segments, which are deemed to be optimal segments in a state without any screening, from being the candidate segments is sufficiently low even when the method for the narrowing down the candidates described in the present exemplary embodiment is employed.

### Second Exemplary Embodiment

Next, a second exemplary embodiment of the present invention will be described in detail with reference to the drawings.

### [2-1] The Configuration of a Speech Synthesis Device According to the Second Exemplary Embodiment

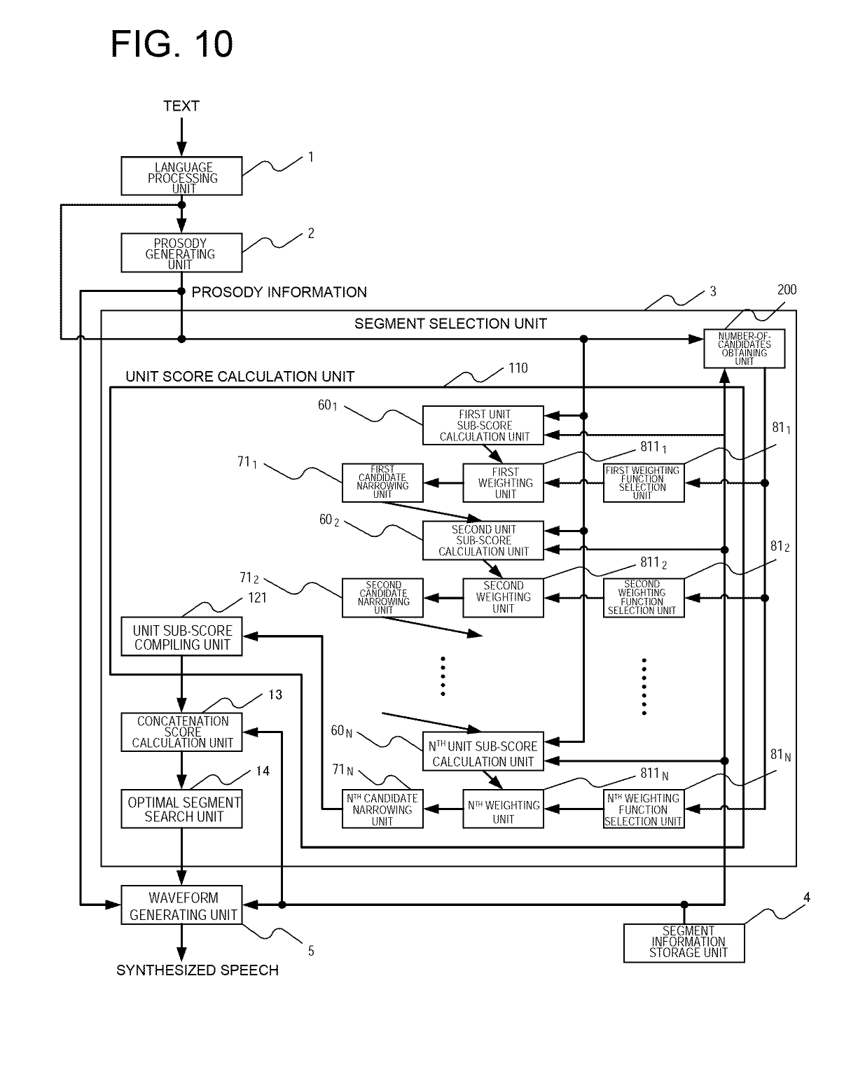

FIG. 10 is a block diagram showing the configuration of the speech synthesis device of the second exemplary embodiment of the present invention. In the configuration of the present exemplary embodiment shown in FIG. 10, the first to the Nth candidate narrowing units 70₁ to 70_{N} and the first to the Nth threshold value calculation units 80₁ to 80_{N} in the first exemplary embodiment are replaced with first to Nth candidate narrowing units 71₁ to 71_{N} and first to Nth weighting function selection units 81₁ to 81_{N} respectively. In addition, the configuration of the present exemplary embodiment newly comprises first to Nth weighting units 811₁ to 811_{N}.

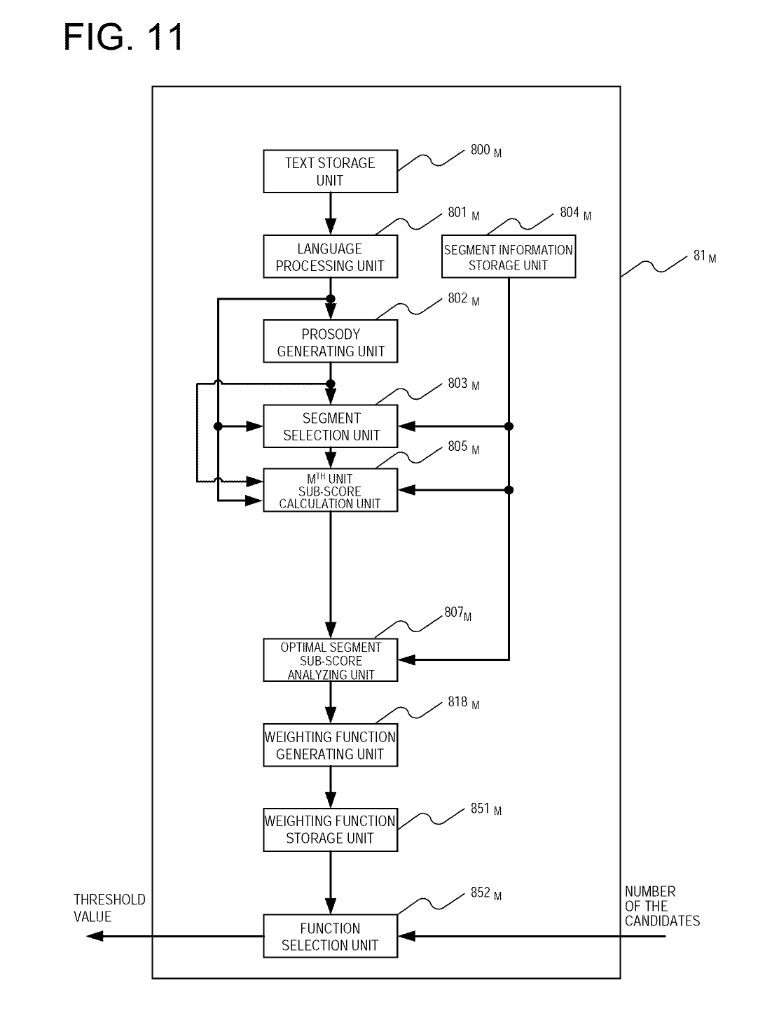

FIG. 11 is a block diagram showing the configuration of the weighting function selection unit 81_{M} in FIG. 10 (where M is any integer from 1 to N). The weighting function selection unit 81_{M} shown in FIG. 11 has a configuration in which the threshold value function generating unit 808_{M} and the threshold value calculation unit 809_{M} of the threshold value calculation unit 80_{M} shown in FIG. 3 are replaced with a weighting function generating unit 818_{M} and a function selection unit 852_{M}, respectively, and a weighting function storage unit 851_{M} is newly provided.

The operation of the speech synthesis device of the second exemplary embodiment will be described in detail with reference to the block diagrams in FIGS. 10 and 11, focusing on the differences mentioned above.

### [2-2] The Operation of the Speech Synthesis Device of the Second Exemplary Embodiment

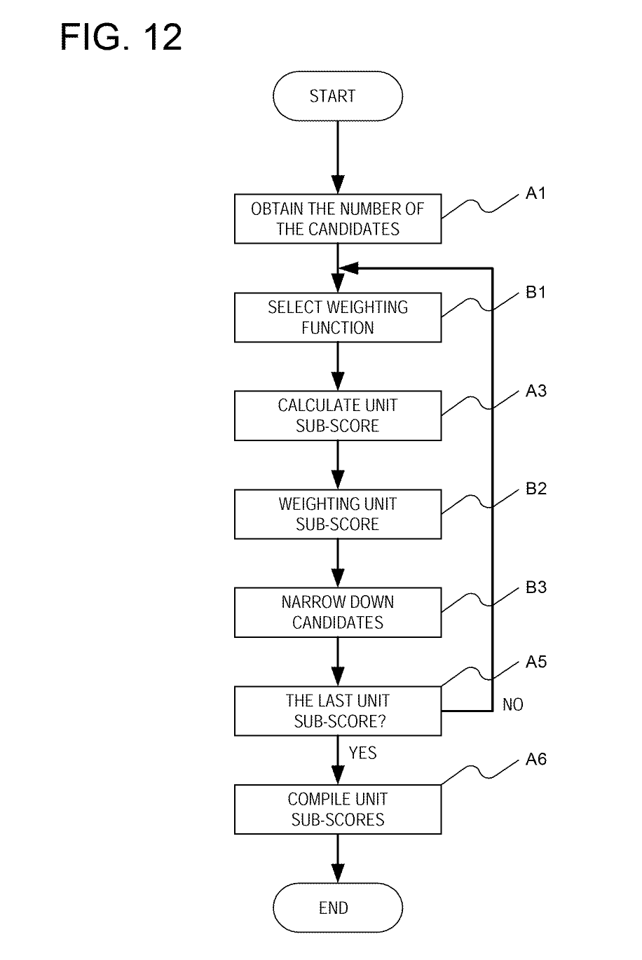

FIG. 12 is a flowchart for explaining the operation of the second exemplary embodiment of the present invention. With reference to the flowchart in FIG. 12, after the number of the candidates is obtained (the step A1), the first weighting function selection unit 81₁ selects a weighting function used for weighting the unit sub-score according to the number of the candidates supplied by the number-of-candidates obtaining unit 200, and transmits the weighting function to the first weighting unit 811₁ and the candidate narrowing unit 71₁ (step B1).

The first unit sub-score calculation unit 60₁ calculates the first unit sub-score according to the language processing results supplied by the language processing unit 1, the prosody information supplied by the prosody generating unit 2, and the segment information stored in the segment information storage unit, and transmits the sub-score to the first weighting unit 811₁ (the step A3).

The first weighting unit 811₁ derives a weight corresponding to the unit sub-score according to the first unit sub-score of each candidate segment supplied by the first unit sub-score calculation unit 60₁ and the weighting function supplied by the first weighting function selection unit 81₁, and weights the unit score with it. Then the first weighting unit 811₁ transmits the weighted unit score along with the candidate segments to the first candidate narrowing unit 71₁ (step B2).

The first candidate narrowing unit 71₁ excludes candidate segments having weighted unit sub-scores lower than a predetermined threshold value according to the candidate segments supplied by the first weighting unit 811₁ and the first weighted unit sub-score of each candidate segment, and transmits the remaining candidate segments and their weighted unit sub-scores to the second unit sub-score calculation unit 60₂ (step B3).

The processing from the step B1 to the step B3 is similarly repeated by the second weighting function selection unit, the second unit sub-score calculation unit, the second weighting unit, and the second candidate narrowing unit through the Nth weighting function selection unit, the Nth unit sub-score calculation unit, the Nth weighting unit, and the Nth candidate narrowing unit until the last unit sub-score is calculated (the step A5). The last Nth candidate narrowing unit 71_{N} transmits the remaining candidate segments and their first through Nth unit sub-scores to the unit sub-score compiling unit 121.

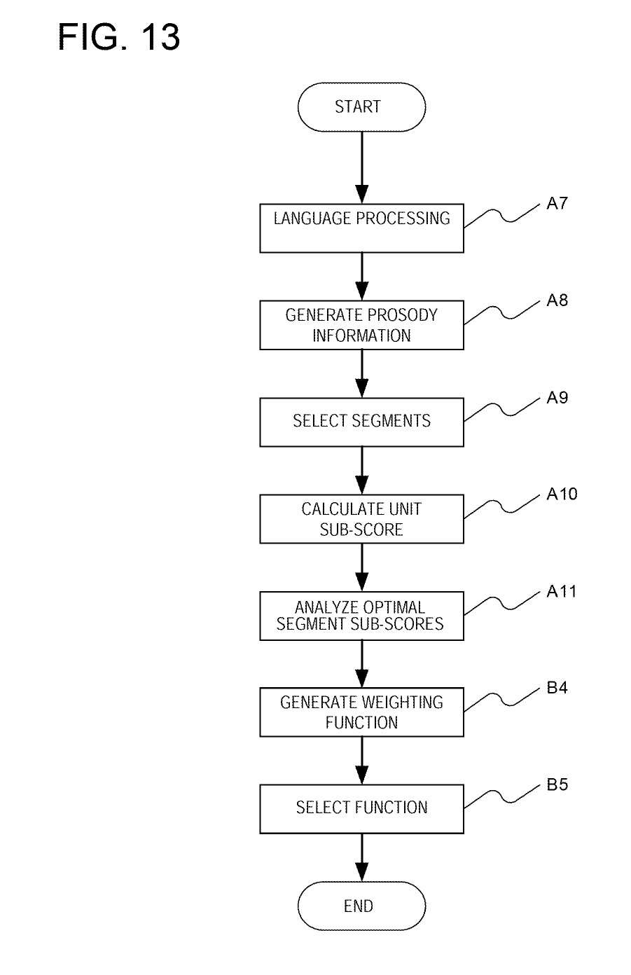

FIG. 13 is a flowchart for explaining the operation of the weighting function generating unit 818_{M} shown in FIG. 11. With reference to the flowchart in FIG. 13, the operation from the step A7 to the step A11 is identical to that of the threshold value function generating unit in the first exemplary embodiment described above. Next, the weighting function generating unit 818_{M} derives a weighting function that derives a weight from a score according to the number of the candidates based on the analysis value supplied by the optimal segment sub-score analyzing unit 807_{M}, and transmits the weighting function to the weighting function storage unit 851_{M} (step B4). In the present exemplary embodiment, explanations will be made with the assumption that the analysis values supplied by the optimal segment sub-score analyzing unit 807_{M} are k1, k2, p 1, p2, and p3, as in the first exemplary embodiment.

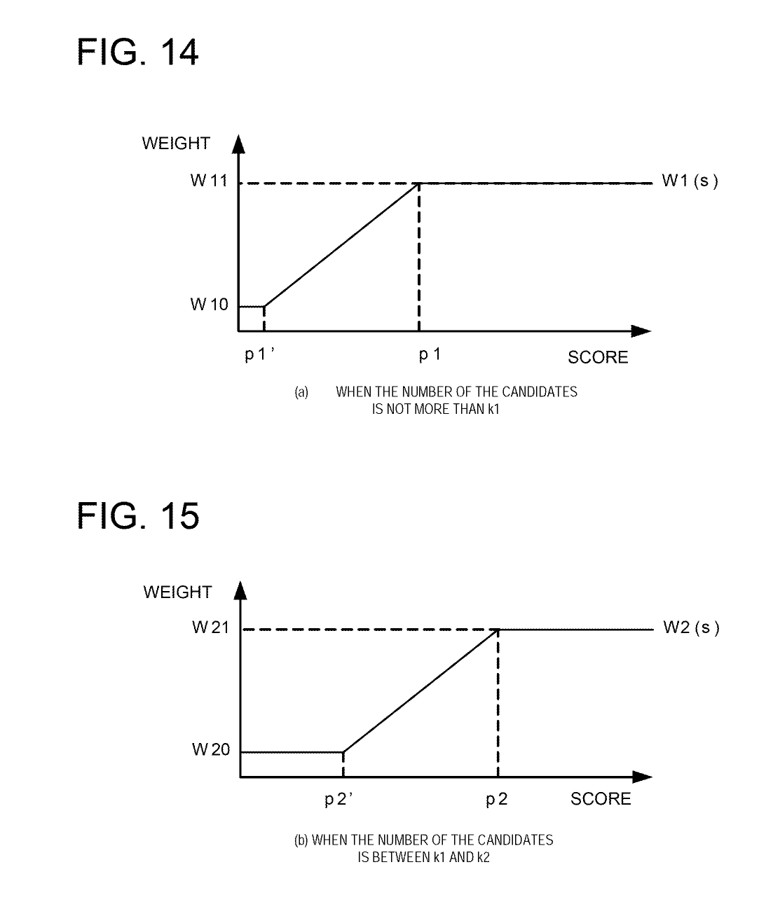

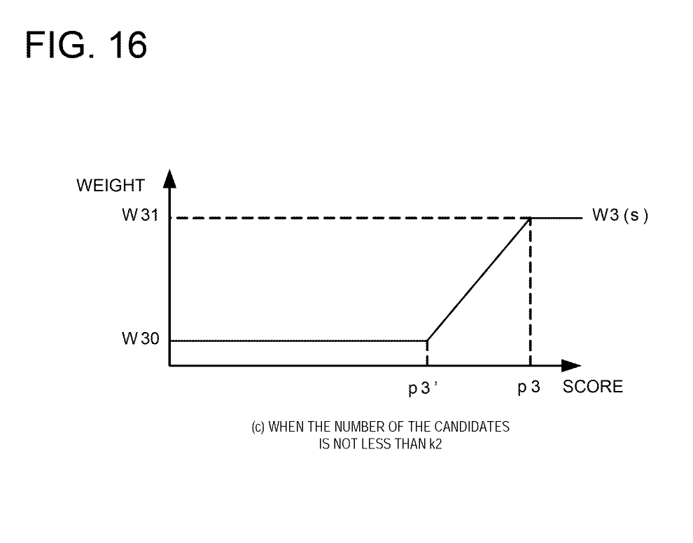

FIGS. 14 to 16 show examples of the threshold value functions designed based on k1, k2, p1, p2, and p3. FIG. 14 shows a function used when the number of the candidates is not more than k1, FIG. 15 shows a function used when the number of the candidates is between k1 and k2, and FIG. 16 shows a function used when the number of the candidates is not less than k2.

With reference to FIG. 14, p1′ is any value smaller than p1, and it is set so that the weight gets smaller when the score is smaller than p1. When p1=p1′, the same effects as in the first exemplary embodiment are obtained. W10 and W11 are any real numbers between 0.0 and 1.0, and W10<W11. Since W10 is the weight used for weighting the sub-score of the segments narrowed down by the weighting unit and the candidate narrowing unit, it should be set to a value sufficiently close to 0.0. In general, W10 and W11 are set as W10=0.0 and W11=1.0. Further, when W10=W11, the weighting unit and the candidate narrowing unit do not narrow down the candidates at all since the same weight is always given regardless of the score value. The above descriptions apply not only to p1′, W10, and W11, but also to p2′, p3′, W20, W21, W30, and W31 in FIGS. 15 and 16. As described, the weighting function generating unit 818_{M} generates different weighting functions according to the number of the candidates.

From the weighting functions stored in the weighting function storage unit 851_{M}, the function selection unit 852_{M} selects a weighting function corresponding to the number of the candidates supplied by the number-of-candidates obtaining unit 200 in FIG. 10, and transmits the weighting function to the Mth weighting unit and the Mth candidate narrowing unit 71_{M} as weighting function information (step B5). Following the above example, the weighting function in FIG. 14 is selected when the number of the candidates is less than k1.

### [2-3] The Effects of the Speech Synthesis Device According to the Second Exemplary Embodiment

According to the present exemplary embodiment, the speech synthesis device that narrows down the candidates using weighted scores rather than the threshold values can be obtained. Particularly, compared to the first exemplary embodiment, the second exemplary embodiment keeps segments excluded in the first exemplary embodiment due to their scores being smaller than the threshold value only by a small value, although their scores are made smaller due to the weight. As a result, speech quality is expected to improve, compared to the first exemplary embodiment, since these remaining segments may contribute to an improvement in speech quality.

### Third Exemplary Embodiment

Next, a third exemplary embodiment of the present invention will be described in detail with reference to the drawings.

### [3-1] The Configuration of a Speech Synthesis Device According to the Third Exemplary Embodiment

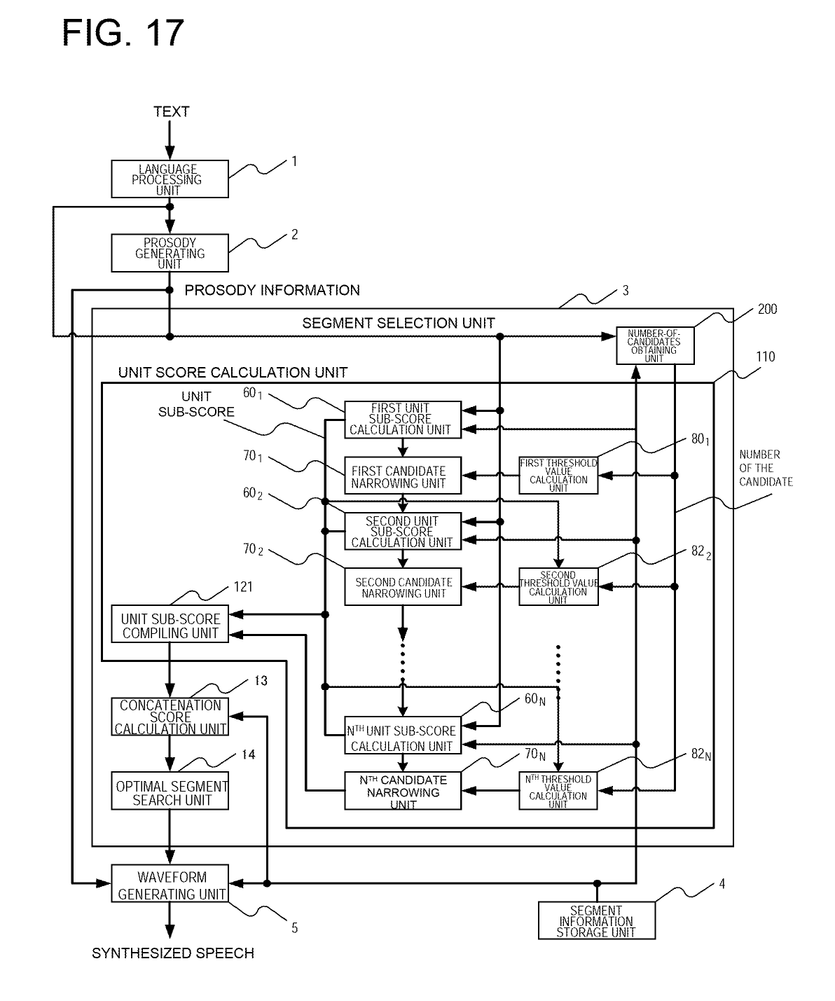

FIG. 17 is a block diagram showing the configuration of the speech synthesis device of the third exemplary embodiment of the present invention. In the configuration of the present exemplary embodiment shown in FIG. 17, the threshold value calculation units from the second stage on, i.e., the second to the Nth threshold value calculation units 80₂ to 80_{N}, in the speech synthesis device of the first exemplary embodiment are replaced with second to Nth threshold value calculation units 82₂ to 82_{N}.

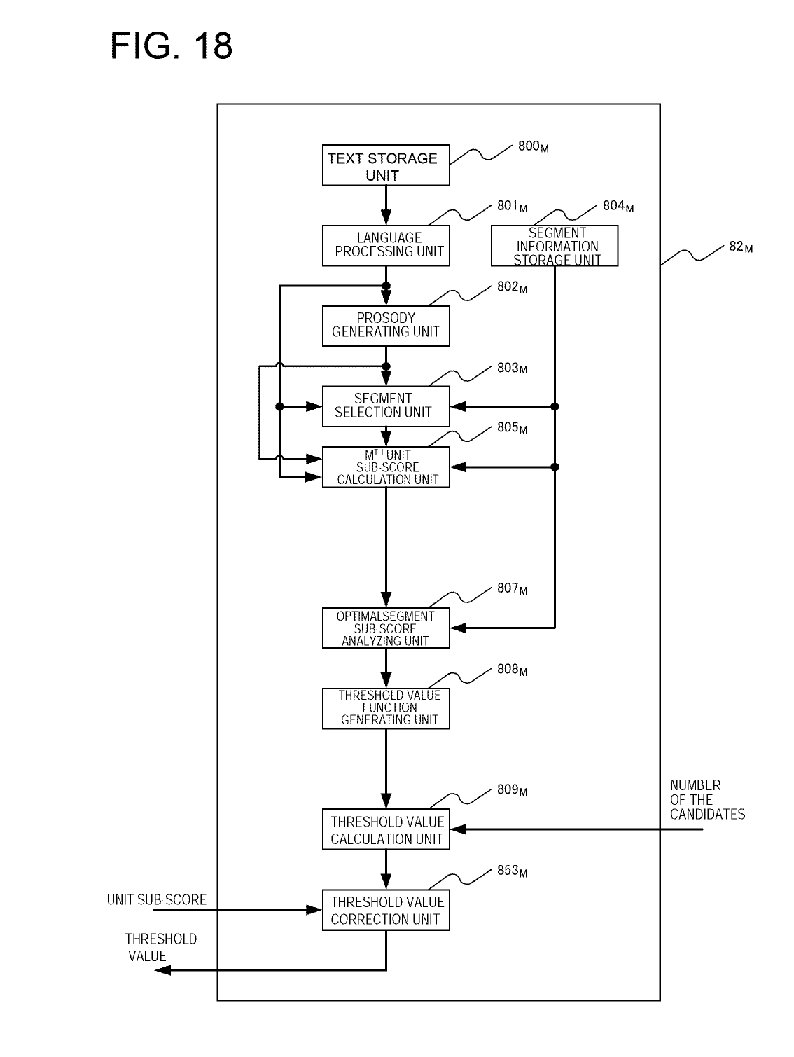

FIG. 18 is a block diagram showing the configuration of the second to Nth threshold value calculation units in FIG. 17 (where M is any integer from 2 to N). The threshold value calculation unit 82_{M} shown in FIG. 18 newly comprises a threshold value correction unit 853_{M}, compared to the threshold value calculation unit 80_{M} in FIG. 3.

The operation of the speech synthesis device of the third exemplary embodiment will be described in detail with reference to the block diagrams in FIGS. 17 and 18, focusing on the differences mentioned above.

### [3-2] The Operation of the Speech Synthesis Device of the Third Exemplary Embodiment

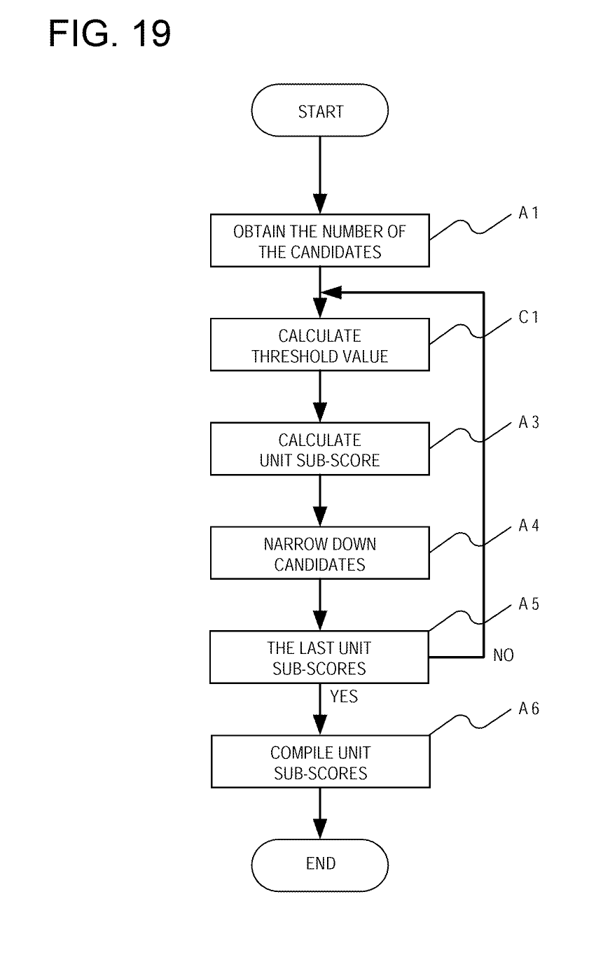

FIG. 19 is a flowchart for explaining the operation of the third exemplary embodiment of the present invention. With reference to the flowchart in FIG. 19, after the number of the candidates is obtained (the step A1) and the calculation performed by the first unit sub-score calculation unit 60₁ based on it is complete, the second threshold value calculation unit 82₂ calculates a threshold value, which will be the reference value for narrowing down the candidates, according to the number of the candidates supplied by the number-of-candidates obtaining unit 200 and the unit sub-score supplied by the first unit sub-score calculation unit 60₁, and transmits the threshold value to the second candidate narrowing unit 70₂ (step C1). The operation thereafter is identical to the first exemplary embodiment described above.

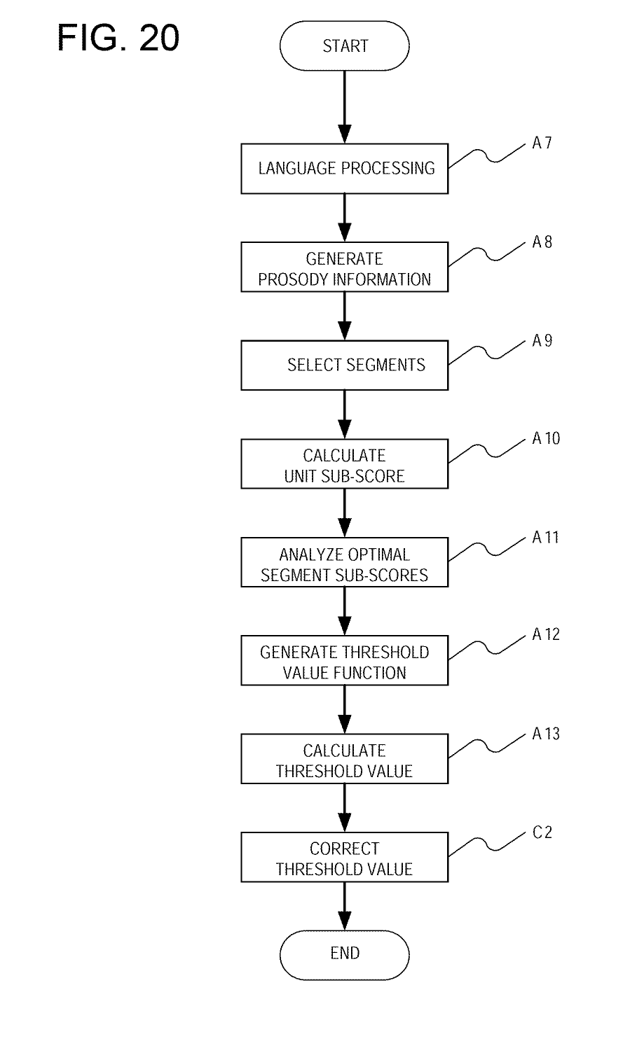

FIG. 20 is a flowchart for explaining the operation of the threshold value calculation unit 82_{M} shown in FIG. 18. With reference to the flowchart in FIG. 20, the operation from the step A7 to the step S13 is identical to the first exemplary embodiment described above. Finally, the threshold value correction unit 853_{M} corrects the threshold value supplied by the threshold value calculation unit 809₁ according to the unit sub-scores supplied by all of the first to the M-1th unit sub-score calculation units 60₁ to 60_{M-1} in FIG. 17, and transmits the result to the Mth candidate narrowing unit 70_{M} (step C2). The main object of the threshold value correction unit 853_{M} is to correct the threshold value so as to prevent segments having high unit sub-scores calculated so far from being excluded as candidates.

Therefore, when there is any unit sub-score having a score exceeding a predetermined threshold value among the supplied unit sub-scores, or when the total sum of the supplied unit sub-scores exceeds the predetermined threshold value, the threshold value is corrected to be smaller. Further, a method in which the threshold value is decreased as the sub-scores increase is effective. On the other hand, when the supplied sub-scores as a whole are small, since the segments are unlikely to be selected as the optimal segments, it is effective to increase the possibility of them being excluded from being the candidates by correcting the threshold value to a larger value. In the present example, all of the first to the M-1th sub-scores are utilized, however a method that utilizes only specific unit sub-scores (for instance only the first unit sub-score, or only the first to the third sub-scores) is effective as well.

### [3-3] The Effects of the Speech Synthesis Device According to the Third Exemplary Embodiment

According to the present exemplary embodiment, the speech synthesis device corrects the threshold value calculated by the Mth threshold value calculation unit according to the values of the first to the M-1th unit sub-scores. More particularly, when the first to the M-1th unit sub-scores include a unit sub-score having a high score, the threshold value is corrected to a smaller value so as to increase the possibility of the segment being selected as an optimal segment. As a result, compared to the first exemplary embodiment, an improvement in speech quality over the first exemplary embodiment can be expected since it is less likely that segments having high unit scores are excluded from being the candidates when the candidates are narrowed down using the Mth unit sub-score.

### Fourth Exemplary Embodiment

Next, a fourth exemplary embodiment of the present invention will be described in detail with reference to the drawings.

### [4-1] The Configuration of a Speech Synthesis Device According to the Fourth Exemplary Embodiment

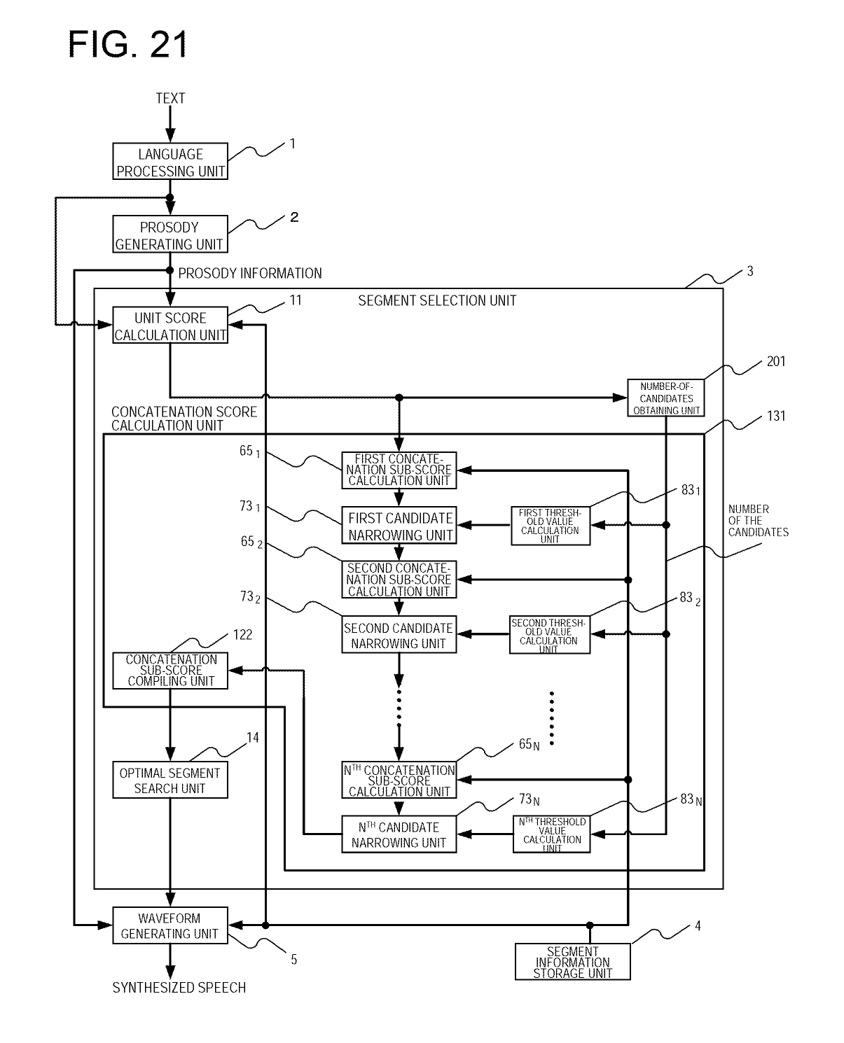

FIG. 21 is a block diagram showing the configuration of the speech synthesis device of the fourth exemplary embodiment of the present invention. The language processing unit 1, the prosody generating unit 2, a unit score calculation unit 11 and the optimal segments search unit 14 in the segment selection unit 3, the segment information storage unit 4, and the waveform generating unit 5 in FIG. 21 respectively correspond to the language processing unit X1, the prosody generating unit X2, the unit score calculation unit X11, the optimal segments search unit X14, the segment information storage unit X4, and the waveform generating unit X5 in FIG. 25. Therefore, the speech synthesis device of the present exemplary embodiment differs from the general rule-synthesis type speech synthesis device in FIG. 25 in that a number-of-candidates obtaining unit 201, first to Nth concatenation sub-score calculation units 65₁ to 65_{N}, first to Nth candidate narrowing units 73₁ to 73_{N}, first to Nth threshold value calculation units 83₁ to 83_{N}, and a concatenation sub-score compiling unit 122 are added.

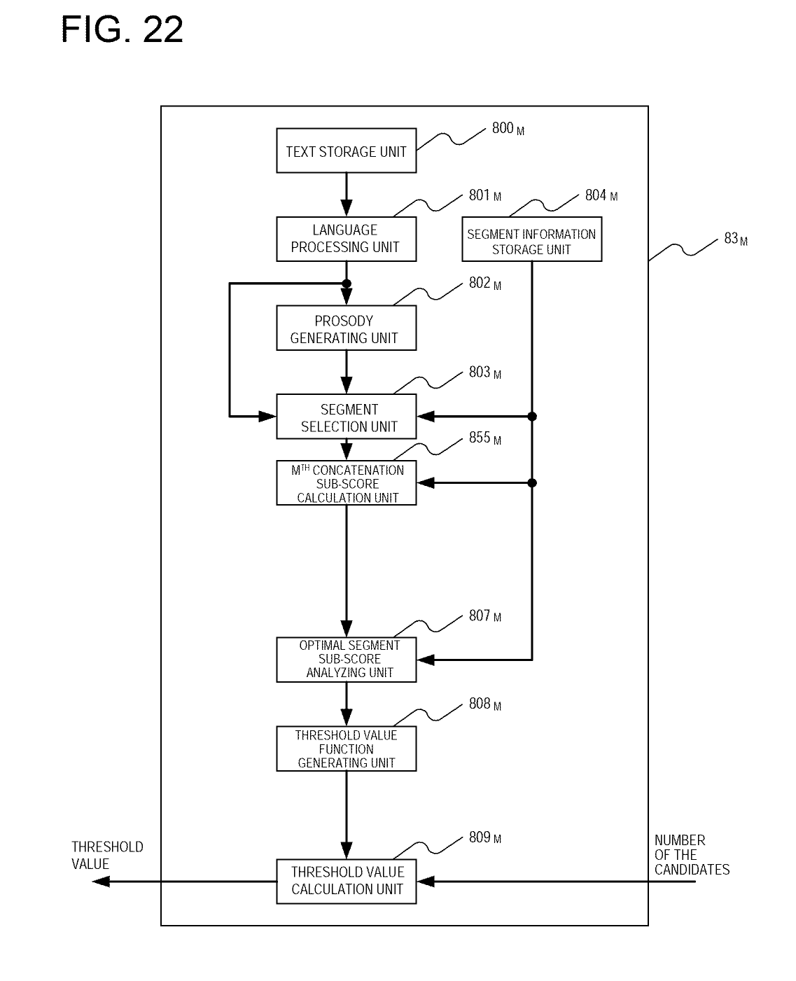

FIG. 22 is a block diagram showing the configuration of the threshold value calculation unit 83_{M} shown in FIG. 21 (where M is any integer from 2 to N). The threshold value calculation unit 83_{M} shown in FIG. 22 has a configuration in which the Mth concatenation sub-score calculation unit 805_{M} of the threshold value calculation unit 80_{M} of the first exemplary embodiment in FIG. 3 is replaced with an Mth concatenation sub-score calculation unit 855_{M}.

The operation of the speech synthesis device according to the fourth exemplary embodiment will be described in detail with reference to the block diagram in FIG. 21 focusing on the differences mentioned above.

### [4-2] The Operation of the Speech Synthesis Device of the First Exemplary Embodiment

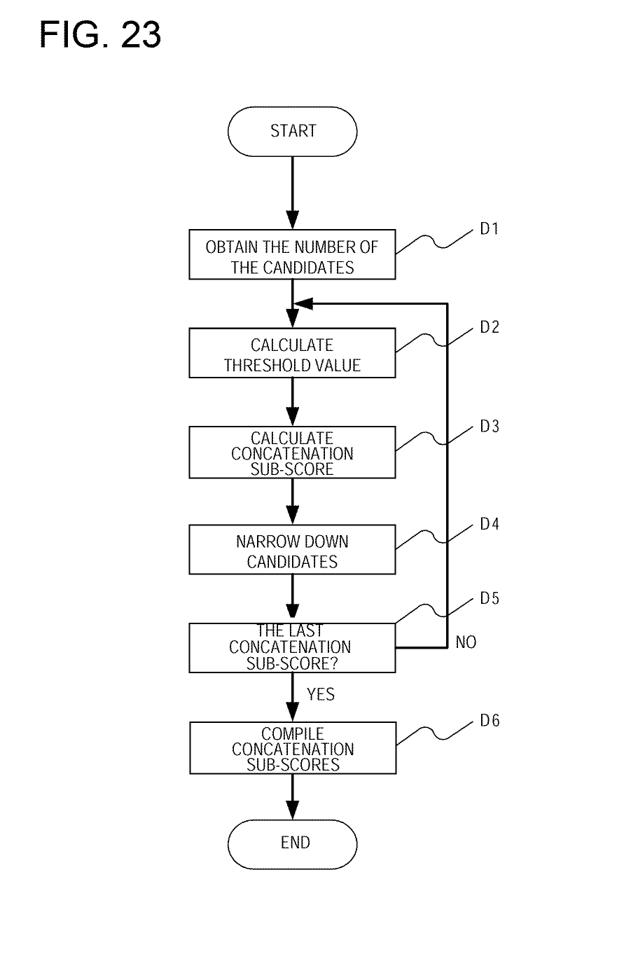

FIG. 23 is a flowchart for explaining the operation of the fourth exemplary embodiment of the present invention. With reference to the flowchart in FIG. 23, the number-of-candidates obtaining unit 201 obtains the number of the remaining candidate segments from the unit score calculation unit 11, and transmits the information to the first to the Nth threshold value calculation units 83₁ to 83_{N} (step D1).

The first threshold value calculation unit 83₁ calculates the threshold value, which will be the reference value for narrowing down the candidates, from the number of the candidates supplied by the number-of-candidates obtaining unit 201, and transmits the threshold value to the first candidate narrowing unit 73₁ (step D2).

The first concatenation sub-score calculation unit 65₁ calculates a first concatenation sub-score according to the candidate segments supplied by the unit score calculation unit 11 and the segment information stored in the segment information storage unit 4, and transmits the concatenation sub-score to the first candidate narrowing unit 73₁ along with the unit scores of the candidate segments supplied by the unit score calculation unit 11 (step D3).

The first candidate narrowing unit 73₁ compares the first concatenation sub-score of each candidate segment supplied by the first concatenation sub-score calculation unit 65₁ to the threshold value supplied by the first threshold value calculation unit 83₁, excludes candidate segments having concatenation sub-scores lower than the threshold value, and transmits the remaining candidate segments and their unit scores and the first concatenation sub-scores to the second concatenation sub-score calculation unit 65₂ (step D4).

The processing from the step D2 to the step D4 is similarly repeated by the second threshold value calculation unit, the second concatenation sub-score calculation unit, and the second candidate narrowing unit through the Nth threshold value calculation unit, the Nth concatenation sub-score calculation unit, and the Nth candidate narrowing unit until the last concatenation sub-score is calculated (step D5). The last Nth candidate narrowing unit 73_{N} transmits the remaining candidate segments, their unit scores, and their first through Nth concatenation sub-scores to the concatenation sub-score compiling unit 122.

The concatenation sub-score compiling unit 122 derives a concatenation score corresponding to each candidate segment according to the candidate segments supplied by the Nth candidate narrowing unit 73_{N} and their first through Nth concatenation sub-scores, and transmits the concatenation scores to the optimal segment search unit 14 along with the candidate segments and the unit scores (step D6). The concatenation score can be derived from the concatenation sub-scores by, for instance, deeming a weighted sum of the concatenation sub-scores to be the concatenation score as in the case of the unit score in the first exemplary embodiment.

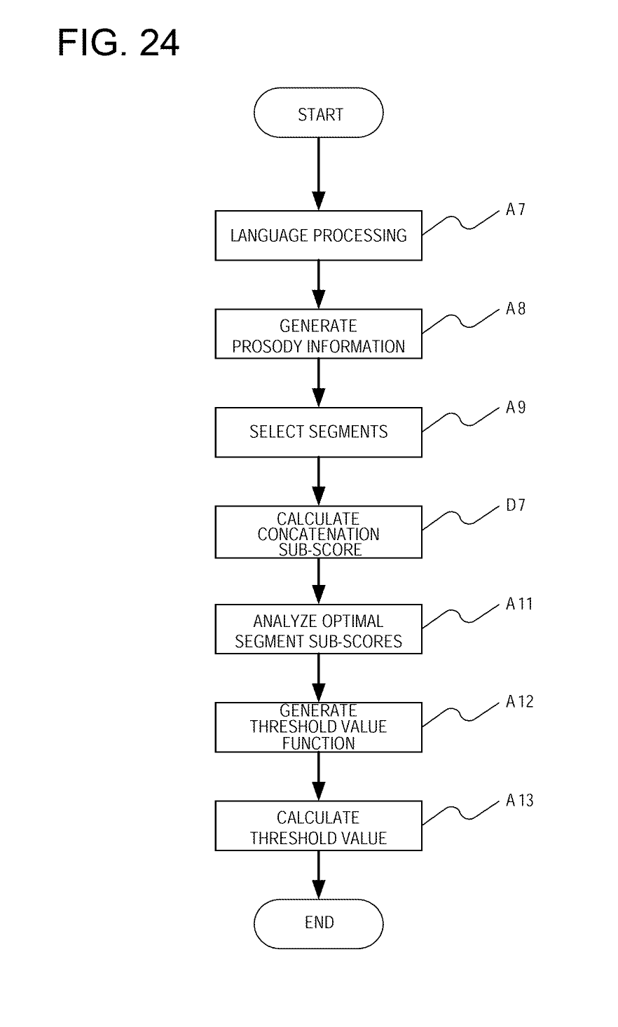

FIG. 24 is a flowchart for explaining the operation of the threshold value calculation unit 83_{M} shown in FIG. 22. The processing from the step A7 to the step A9 and the processing from the step A11 to the step A13 in the flowchart in FIG. 24 are identical to the corresponding processing in the first exemplary embodiment described above. The Mth concatenation sub-score calculation unit 855_{M} calculates an Mth concatenation sub-score of the optimal segment supplied by the segment selection unit 803_{M} according to the segment information stored in the segment information storage unit 804_{M}, and transmits the sub-score to the optimal segment sub-score analyzing unit 807_{M} (step D7).

The Mth concatenation sub-score calculation unit 855_{M} differs from the Mth concatenation sub-score calculation unit 65_{M} in FIG. 21 in that the Mth concatenation sub-score calculation unit 855_{M} only calculates the Mth concatenation sub-scores of the optimal segments obtained by the segment selection unit 803_{M} whereas the Mth concatenation sub-score calculation unit 65_{M} calculates the Mth concatenation sub-scores of all the candidate segments. Since the detail of the operation of the Mth concatenation sub-score calculation unit 855_{M} is equivalent to the Mth concatenation sub-score calculation unit 65_{M} in FIG. 21, the explanation of it will be omitted.

### [4-3] The Effects of the Speech Synthesis Device According to the Fourth Exemplary Embodiment

According to the present exemplary embodiment, the speech synthesis device that narrows down the candidates can be obtained using the concatenation sub-score rather than the unit sub-score. As a result, the entire calculation amount required for calculating the concatenation scores can be reduced. Particularly, in cases where the calculation amount required for the unit scores is small, the types of the concatenation sub-scores are many, and the calculation amount required for the concatenation sub-scores is large, the calculation amount can be reduced greatly, compared to the first to the third exemplary embodiments described above.

### Fifth Exemplary Embodiment

When the candidates are narrowed down using the concatenation sub-scores, a method that narrows down candidates having a high possibility of being an optimal segment by selecting a weighting function as in the second exemplary embodiment described above and weighting the score according to the number of the candidates can be employed. In this case, compared to the fourth exemplary embodiment, the fifth exemplary embodiment keeps segments hitherto excluded due to their scores being smaller than the threshold value only by a small value, although their scores are made smaller due to the weight. As a result, an improvement in speech quality over the fourth exemplary embodiment can be expected, since these remaining segments may contribute to an improvement in speech quality.

### Sixth Exemplary Embodiment

When the candidates are narrowed down using the concatenation sub-scores, a method that narrows down candidates having a high possibility of being an optimal segment after the threshold value obtained according to the number of the candidates has been corrected according to the scores as in the third exemplary embodiment described above can be employed. In this case, compared to the fourth exemplary embodiment, since segments having high unit scores are less likely to be excluded from being the candidates when they are narrowed down using the Mth unit sub-scores, an improvement in speech quality over the fourth exemplary embodiment can be expected.

The present invention is not limited to the exemplary embodiments described above, and further variations, replacements, and adjustments may be added within the scope of the basic technological concept of the present invention. For instance, [EXPRESSION 1] is used as an example to calculate the score C in the exemplary embodiments described above, however, various score (cost) calculation formulas in Patent Documents 1 and 2 and Non-Patent Documents may be used instead.

Further, the configurations and operations of the speech synthesis devices are mainly described in the exemplary embodiments described above, however, the speech synthesis devices described above can be realized by a program having a computer function as each means of the speech synthesis devices described above and a program having each procedure of the speech synthesis devices described above executed.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed segments, matters and/or items may fall under the modifications aforementioned.

What is claimed is:

1-21. (canceled)

22. A speech synthesis device comprising:
a sub-score calculation unit that calculates a segment selection sub-score for selecting an optimal segment;
a threshold value calculation unit that derives a threshold value according to the number of said candidate segments; and
a candidate narrowing unit that narrows down candidates according to said threshold value and said segment selection sub-score.

23. The speech synthesis device as defined in claim 22, wherein said segment selection sub-score includes either a unit sub-score or a concatenation sub-score.

24. The speech synthesis device as defined in claim 22, wherein said threshold value calculation unit derives a higher threshold value when the number of said candidate segments is high than a case where the number of said candidate segments is low.

25. The speech synthesis device as defined in claim 22, wherein said threshold value calculation unit derives a threshold value using a segment selection sub-score.

26. The speech synthesis device as defined in claim 22, wherein said threshold value calculation unit derives a threshold value according to statistics of the segment selection sub-score of an optimal segment.

27. The speech synthesis device as defined in claim 22, comprising:
a weighting function selection unit that selects a weighting function according to the number of candidate segments, and a weighting unit that weights said segment selection score according to said weighting function and said segment selection score, said weighting function selection unit and said weighting unit being disposed preceding to said candidate narrowing unit; wherein
said candidate narrowing unit narrows down candidates according to said weighted segment selection score.

28. A speech synthesis method, in a speech synthesis device that generates synthesized speech from an input text, comprising:
calculating a segment selection sub-score for selecting an optimal segment; and
narrowing down candidates according to a threshold value, derived according to the number of said candidate segments, and said segment selection sub-score in a process of selecting an optimal segment.

29. The speech synthesis method as defined in claim 28, wherein said segment selection sub-score includes either a unit sub-score or a concatenation sub-score.

30. The speech synthesis method as defined in claim 28, wherein a higher threshold value is applied when the number of said candidate segments is high than a case where the number of said candidate segments is low.

31. The speech synthesis method as defined in claim 28, wherein said threshold value is derived using a segment selection sub-score.

32. The speech synthesis method as defined in claim 28, wherein said threshold value calculation unit derives a threshold value according to statistics of the segment selection sub-score of an optimal segment.

33. The speech synthesis method as defined in claim 28, wherein selecting a weighting function according to the number of candidate segments and weighting said segment selection score according to said weighting function and said segment selection score are performed preceding to said narrowing down candidates; and
narrowing down candidates according to said weighted segment selection score is performed.

34. A program having a computer, constituting a speech synthesis device that generates synthesized speech from an input text, execute:
in a process of selecting an optimal segment for generating synthesized speech from an input text,
processing of calculating a segment selection sub-score for selecting an optimal segment;
processing of deriving a threshold value according to the number of said candidate segments; and
candidate narrowing processing of narrowing down candidates according to said threshold value and an said segment selection sub-score.

35. The program as defined in claim 34, wherein said segment selection sub-score includes either a unit sub-score or a concatenation sub-score.

36. The program as defined in claim 34, wherein said threshold value calculation processing derives a higher threshold value when the number of said candidate segments is high than a case where the number of said candidate segments is low.

37. The program as defined in claim 34, wherein said threshold value calculation processing derives a threshold value using a segment selection sub-score.

38. The program as defined in claim 34, wherein said threshold value calculation processing derives a threshold value according to statistics of the segment selection sub-score of an optimal segment.

39. The program as defined in claim 34, having said computer execute:
weighting function selection processing of selecting a weighting function according to the number of candidate segments, and weighting processing of weighting said segment selection score according to said weighting function and said segment selection score, preceding to said candidate narrowing processing; wherein
said candidate narrowing processing narrows down candidates according to said weighted segment selection score.
